(19) United States
(12) Patent Application Publication
(10) Pub. No.: US 2013/0285817 A1
(43) Pub. Date: Oct. 31, 2013

(54) CUSTOMIZABLE ALARM SYTEM AND METHOD FOR COMPUTER

(71) Applicants: HONG FU JIN PRECISION INDUSTRY (WUHAN) CO., LTD., (US); HON HAI PRECISION INDUSTRY CO., LTD., New Taipei (TW)

(72) Inventor: YONG-ZHAO HUANG, Shenzhen (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/862,519

(22) Filed: Apr. 15, 2013

(30) Foreign Application Priority Data
Apr. 28, 2012 (CN) 201210128526.9

(51) Int. Cl. G08B 21/18

(52) U.S. Cl. CPC G08B 21/182
USPC 340/584; 340/540; 340/636.15

(57) ABSTRACT

A customizable alarm system includes a graphic user interface (GUI), a central processing unit (CPU) to set a predetermined range of a first electronic element through the GUI, an embedded controller (EC) to store the predetermined range of the first electronic element, and an audio chip. The EC obtains an actual value of the first electronic element, and determines whether the actual value of the first electronic element is within the predetermined range. The EC generates an audio code in response to the actual value not being within the predetermined range. The audio chip receives the audio code, and chooses a corresponding audio file from a plurality of audio files stored in the audio chip. A speaker plays the audio file.

### BACKGROUND

1. Technical Field

The present disclosure relates to an alarm system and an alarm method for a computer, especially to a customizable alarm system and method.

2. Description of Related Art

Element of electronic devices need to be in proper working condition, to allow maximum performance. For example, a central processing unit (CPU) has best performance during the temperature of −45 to 60 degrees. When the temperature exceeds 65 degrees, the CPU may malfunction. However, after working for a period of time a CPU may malfunction at 60 degrees, thus can cause problems during normal use.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an alarm system for a computer of the present disclosure.

FIG. 2 is a flow chart of an embodiment of an alarm method for a computer of the present disclosure.

### DETAILED DESCRIPTION

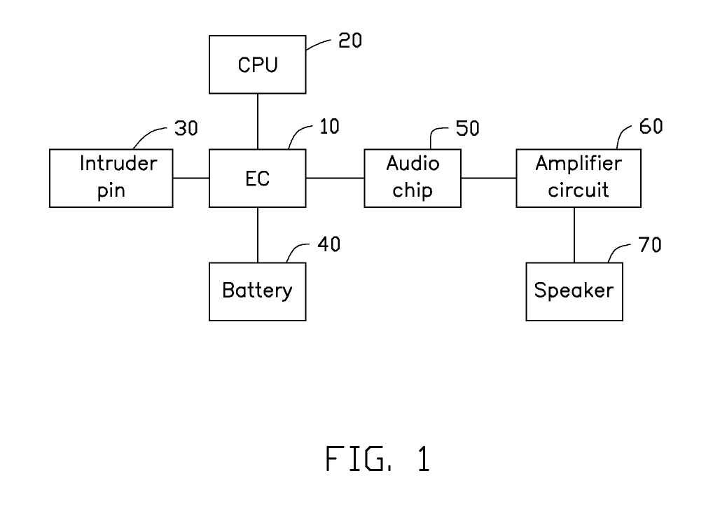

FIG. 1 illustrates an embodiment of an alarm system for a computer of the present disclosure. The alarm system includes an embedded controller (EC) 10, a central processing unit (CPU) 20, an intruder pin 30, a battery 40, an audio chip 50, an amplifier 60, and a speaker 70.

The CPU 20 may control a display to display a graphic user interface (GUI) where a user can input a predetermined range or parameter corresponding to each electronic element. For example, the user may set a temperature range of the CPU 20 between −10 and 59 degrees.

The EC 10 is configured to store the predetermined range or parameter corresponding to each electronic element. The EC 10 is also configured to obtain an actual value of each electronic element in real time, and determine whether the actual value is within the predetermined range or equal to the predetermined parameter. The EC 10 generates an audio code in response to the actual value not being within the predetermined range or equal to the predetermined parameter. For example, if the actual value of the CPU 20 is 60 degrees, the EC 10 will generate the audio code with “010101”.

The audio chip 50 stores a plurality of audio files with respect to different conditions that the electronic elements may encounter. The audio chip 50 is configured to receive the audio code from the EC 10, and obtain an audio file from the plurality of audio files according to the audio code, and transmits the audio file to the amplifier circuit 60. The speaker 70 is configured to play the amplified audio file. In one embodiment, when the audio chip 50 receives the audio code “010101”, the speaker 70 will sound with “your system is running too hot”.

A chassis of the computer may be protected from being opened. According to the working principle of the intruder pin 30, when the chassis is closed, the intruder pin 30 may output a control signal with low level, and when the chassis is opened, the intruder pin 30 may output the control signal with high level. Accordingly, the EC 10 stores a high level voltage regarded as a predetermined parameter when the chassis is in a protection mode. At that time, the EC 10 obtains the control signal from the intruder pin 30, to determine whether the control signal from the intruder pin 30 is equal to the predetermined parameter. If the control signal is not equal to the predetermined parameter, i.e., the control signal from the intruder pin 30 is at low level, the EC 10 generates the audio code with “010111”, and transmits the audio code to the audio chip 50. The audio chip 50 obtains an audio file according to the audio code, and the speaker 70 may sound with “Attention, the chassis is being tampered with”.

The predetermined range of the battery 40 can also be set through the GUI. In one embodiment, the predetermined range of the battery 40 may be set as 20%-100% of the maximum voltage of the battery 40, and stored by the EC 10. The EC 10 obtains the rest voltage of the battery 40, and determines whether the rest voltage is within the predetermined range. The EC 10 generates an audio code, “01111” for example, in response to the rest voltage of the battery 40 not being within the predetermined range. The audio code is transmitted to the audio chip 50, and the audio chip 50 obtains an audio file according to the audio code, and transmits the amplified audio file to the speaker 70 through the amplifier 60. The speaker 70 may sound with “Low battery, please charge”.

In other embodiments, the parameters of the hard disk drives and memory can also be set through the GUI by the user.

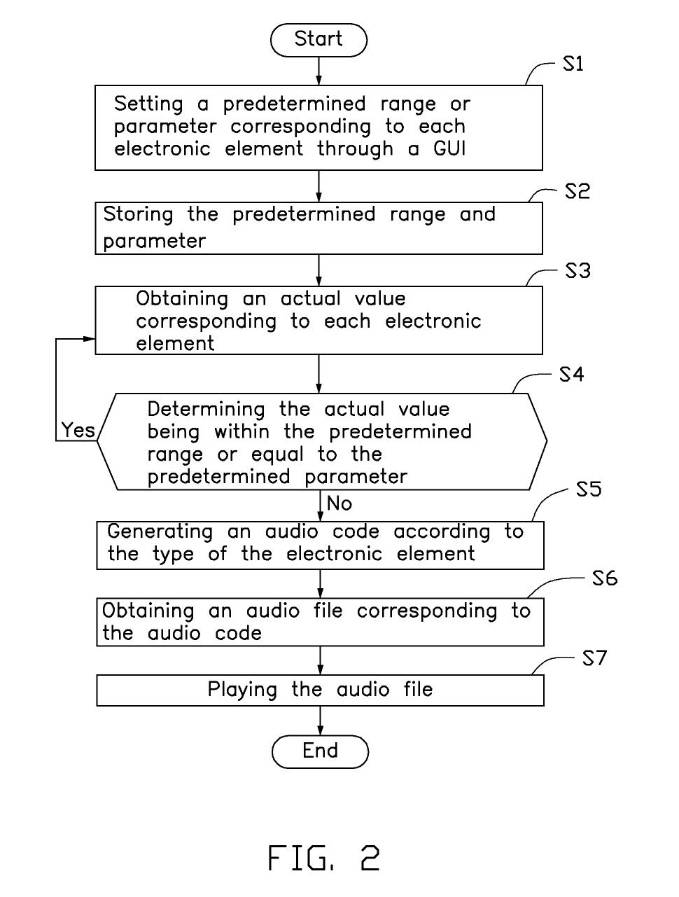

FIG. 2 illustrates an alarm method of the present disclosure. The alarm method includes steps shown below.

In step S1, the predetermined range or parameter corresponding to each electronic element is set through the GUI by the user.

In step S2, the EC 10 stores the predetermined range and parameter corresponding to each electronic element.

In step S3, the EC 10 obtains the actual value of each electronic element.

In step S4, the EC 10 determines whether the actual value is within the predetermined range or equal to the predetermined parameter. If the actual value is within the predetermined range or equal to the predetermined parameter, the process returns to the step S3. Otherwise, step S5 is implemented.

In step S5, the EC 10 generates an audio code according to the type of the electronic element.

In step S6, the audio chip 50 obtains an audio file corresponding to the audio code. The amplifier 60 amplifies the audio file.

In step S7, the speaker 70 plays the amplified audio file.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An alarm system, comprising:
a graphic user interface (GUI);
a central processing unit (CPU) configured to set a predetermined range of a first electronic element through the GUI;
an embedded controller (EC) configured to store the predetermined range of the first electronic element, wherein the EC obtains an actual value of the first electronic element, and determines whether the actual value of the first electronic element is within the predetermined range, the EC generates an audio code in response to the actual value not being within the predetermined range;
an audio chip configured to receive the audio code, and choose a corresponding audio file from a plurality of audio files stored in the audio chip; and
a speaker configured to play the audio file.

2. The alarm system of claim 1, wherein the CPU is configured to set a predetermined parameter of a second electronic element, the EC determines whether an actual value of the second electronic element is equal to the predetermined parameter, and the EC generates an audio code to the audio chip in response to the actual value of the second electronic element being not equal to the predetermined parameter.

3. The alarm system of claim 2, wherein the second electronic element is an intruder pin, and the predetermined parameter is a high level control signal.

4. The alarm system of claim 1, wherein the first electronic element is the CPU, and the predetermined range of the CPU is a temperature range.

5. The alarm system of claim 1, wherein the first electronic element is a battery, and the predetermined range of the battery is a voltage range of the battery.

6. An alarm method, comprising the following steps:
setting a predetermined range of a first electronic element through a graphic user interface (GUI);
storing the predetermined range;
obtaining an actual value of the first electronic element;
determining whether the actual value of the first electronic element is within the predetermined range;
generating an audio code in response to the actual value of the first electronic element not being within the predetermined range;
obtaining an audio file according to the audio code; and
playing the audio file.

7. The alarm method of claim 6, wherein the first electronic element is a CPU, and the predetermined range of the CPU is a temperature range.

8. The alarm method of claim 6, wherein the first electronic element is a battery, and the predetermined range of the battery is a voltage range of the battery.

9. The alarm method of claim 6, further comprising:
setting a predetermined parameter of a second electronic element through the GUI;
storing the predetermined parameter;
obtaining an actual value of the second electronic element;
determining whether the actual value of the second electronic element is equal to the predetermined parameter; and
generating an audio code in response to the actual value of the second electronic element being not equal to the predetermined parameter.

10. The alarm method of claim 9, wherein the second electronic element is an intruder pin, and the predetermined parameter is a high level control signal.
